(19) United States
(12) Patent Application Publication
(10) Pub. No.: US 2010/0043579 A1
(43) Pub. Date: Feb. 25, 2010

(54) ROTARY DEVICES

(76) Inventor: Christopher P. Walters, West Sussex (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/604,689

(22) Filed: Oct. 23, 2009

Related U.S. Application Data
(63) Continuation of application No. 10/546,120, filed on Feb. 8, 2006.

(30) Foreign Application Priority Data
Feb. 21, 2003 (GB) 0304057.3

(51) Int. Cl. F16H 55/14

(52) U.S. Cl. 74/411

(57) ABSTRACT

A rotary device, for example in the form of a gear wheel, comprises a hub (2) and an outer element (4) carrying teeth (28). The outer element (4) is provided with resilient fingers (20) which frictionally engage cam surfaces (38) provided on the hub (2). Relative rotation between the hub (2) and the outer element (4) is resisted by deflection of the fingers (20). Relative rotation between the hub (2) and the outer element (4) is limited by engagement between projections (32) and recesses (34). A combination of torsional spring force created by the flexible fingers together with friction between the fingers (20) and the cam surfaces (38) and between the recesses (46) and the projections (32) provide a damping effect which serves to limit the transmission of torsional vibrations between the hub (2) and the outer element (4).

This invention relates to rotary devices and is particularly, although not exclusively, concerned with a rotary device in the form of a gear wheel.

In some circumstances, for example in valve control mechanisms in internal combustion engines, the driven input of a gear train is subject to torsional vibration, and it is desirable for these vibrations to be eliminated so that they do not affect the performance of the valve gear.

It is known, for example from EP 0312710, for gear sets to include resilient components so as to decouple torsional vibrations. EP 0312710 discloses a centre gear disposed between two coaxial toothed discs which are resiliently biased in opposite directions so that torsional fluctuations are absorbed by relative rotation between the centre gear and the discs. However, this arrangement is relatively complex to assemble, and also requires specific measures when setting up the gear mechanism so that the centre gear and the discs properly engage adjacent gear wheels of the mechanism.

According to the present invention there is provided a rotary device comprising inner and outer elements, one of the elements having a cantilevered resilient finger, a free end of which frictionally engages a cam surface on the other element thereby to provide resilient resistance to relative rotation of the elements in either direction from a minimum energy position, with damping of rotational oscillations between the elements.

With such a rotary device, relative rotation between the elements, as caused by torsional vibrations applied to one of the elements, is accompanied by deflection of the finger, which thus resiliently resists the rotation. At the same time, rubbing of the resilient finger against the cam surface creates the required variable friction damping action. Thus the resilient finger exerts a torsional spring force, with damping. The spring rate of the system can be optimised to create a desired response to torsional vibrations.

In a preferred embodiment, the cam surface comprises a pair of ramp portions inclined in opposite directions away from a minimum energy position so that the deflection of the finger increases as the finger moves away from the minimum energy position in either direction.

The gradient of each ramp portion preferably decreases as the ramp portion approaches the minimum energy position. In this context, the gradient is understood to be the slope of the respective ramp portion with respect to the tangential direction at the position of the ramp portion being considered. In the preferred embodiment, the cam surface is concavely curved in the region of the minimum energy position, the radius of curvature of the cam surface decreasing as the minimum energy position is approached.

The finger has a contact surface which engages the cam surface, this contact surface being convexly curved so that, at the point of contact between the contact surface and the cam surface, the radius of curvature of the contact surface is always less than or equal to the radius of curvature of the contacted portion of the cam surface.

Stop means is preferably provided to limit relative rotation between the inner and outer elements. The stop means is preferably situated away from the cam surface. It is currently expected that, in most practical embodiments, a maximum relative rotation of not more than 10° (i.e. ±5° from a neutral position) will be appropriate. In a currently preferred embodiment, the stop means provides for a maximum relative rotation of approximately 6° (i.e. ±3°).

The stop means may comprise a recess in one of the elements defined by spaced apart walls which extend generally radially, with respect to the axis of rotation of the rotary device, a projection on the other element being situated within the recess and having a circumferential extent which is smaller than the spacing between the walls. The base of the recess is preferably arcuate and supports the projection at a correspondingly shaped contact surface to permit limited rotation of the outer element on the inner element.

The projection may have at least one resilient extension which resiliently contacts the base of the recess to enhance the frictional resistance to relative rotation between the inner and outer elements. The or each extension may act as a cantilevered beam extending circumferentially with respect to the axis of the rotary device.

In order to increase frictional damping, a resiliently mounted plunger may be provided in the element having the recess, this plunger engaging the projection.

The finger preferably extends generally tangentially with respect to the axis of rotation of the rotary device so that any deflection of the finger caused by relative displacement between the finger and the cam surface takes place in a generally radial direction. In a preferred embodiment, a plurality of fingers and respective cam surfaces is provided. For example, there may be eight fingers and respective cam surfaces disposed as four pairs, with the fingers of each pair projecting in the direction towards each other.

Since the torsional damping effect increases with the radial distance of the frictional surfaces from the axis of rotation of the device, it is preferable for the finger or fingers to be provided on the outer element of the device, and the cam surface or surfaces to be provided on the inner element. Another benefit of situating the finger or fingers as far as possible from the axis is that this provides the greatest freedom of design with regard to the length of the or each finger, so enabling control of its resilient characteristics. The inner element may be of polygonal form, for example square, with the cam surfaces situated at the apices of the polygon. With such a configuration, the stop means, if provided, may be situated generally at the centre of each side of the polygon.

The rotary device may be a toothed gear wheel, but alternatively it may comprise a transmission element of a different form, such as a pulley wheel or sprocket wheel, or it may comprise a non-transmitting component of a rotary mechanism such as a torsional damper.

For a better understanding of the present invention, and to show more clearly how it may be carried into effect, reference will now be made, by way of example, to the accompanying drawings, in which:

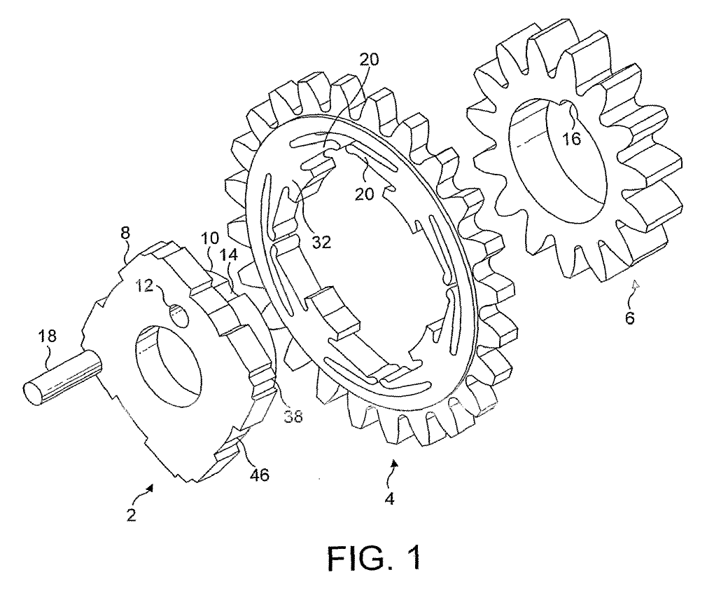

FIG. 1 is an exploded perspective view of a rotary device in the form of a gear wheel assembly;

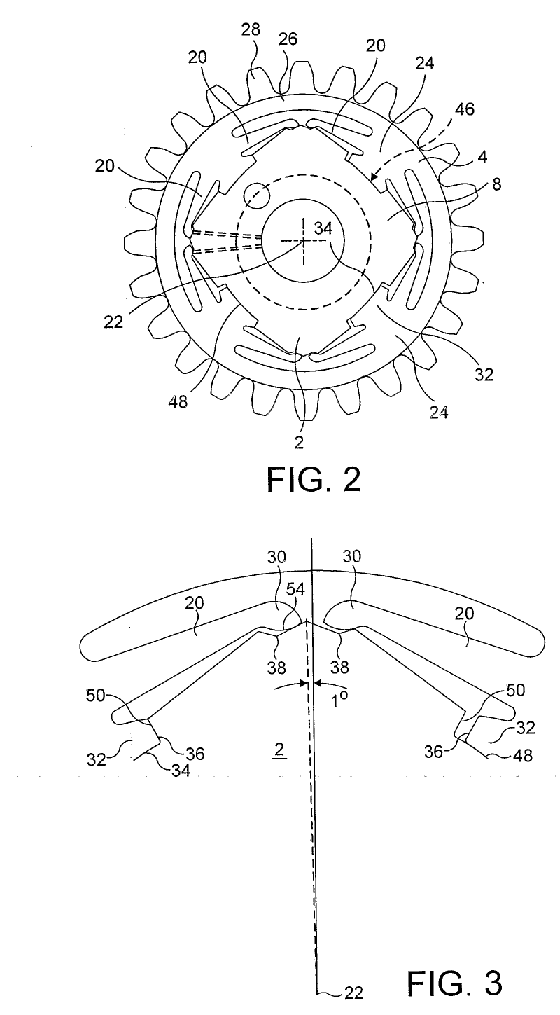

FIG. 2 is an end view of the gear wheel assembly of FIG. 1;

FIG. 3 is an enlarged view of part of the assembly;

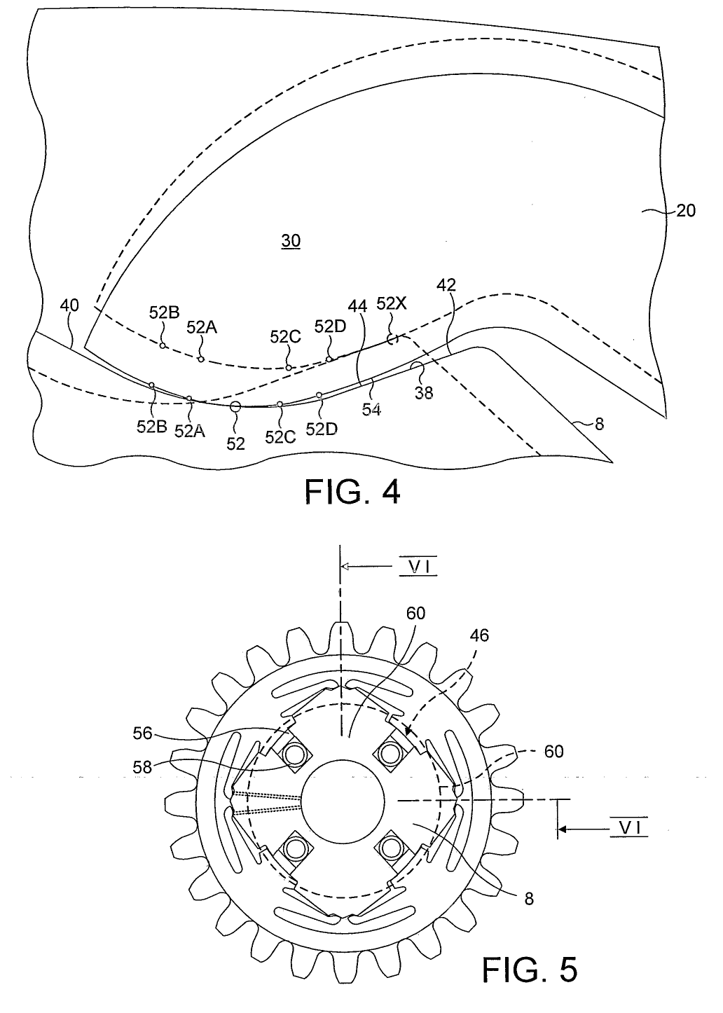

FIG. 4 is a further enlarged view;

FIG. 5 corresponds to FIG. 2 but shows an alternative embodiment;

FIG. 6 is a section on the line VI-VI in FIG. 5;

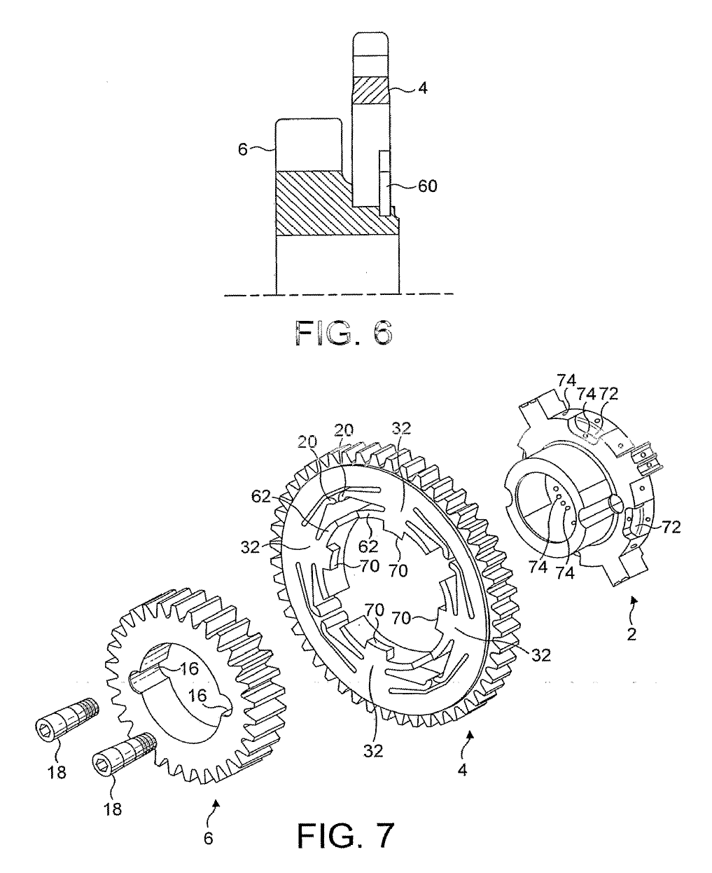

FIG. 7 is an exploded perspective view of a further alternative embodiment;

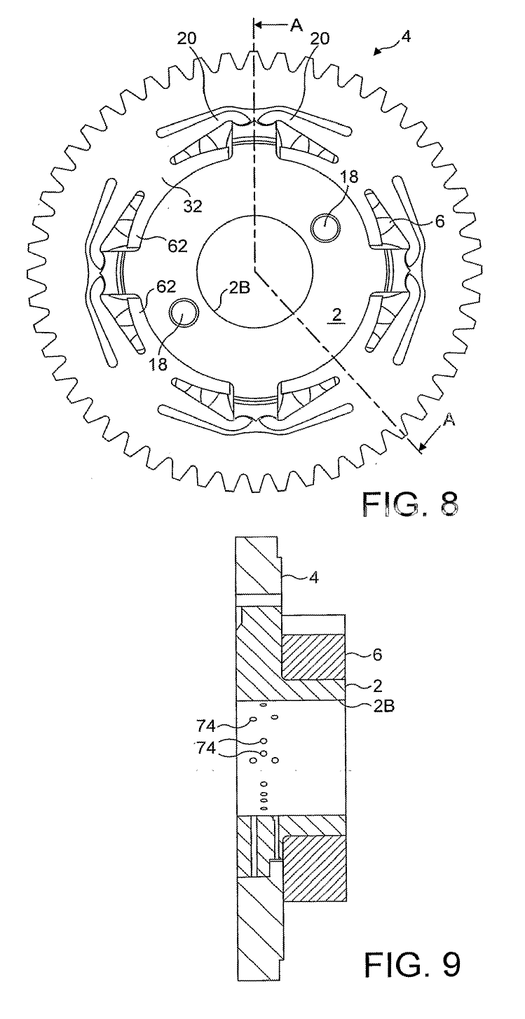

FIG. 8 corresponds to FIG. 2 but shows the embodiment of FIG. 7;

FIG. 9 is a sectional view taken on the line A-A in FIG. 8;

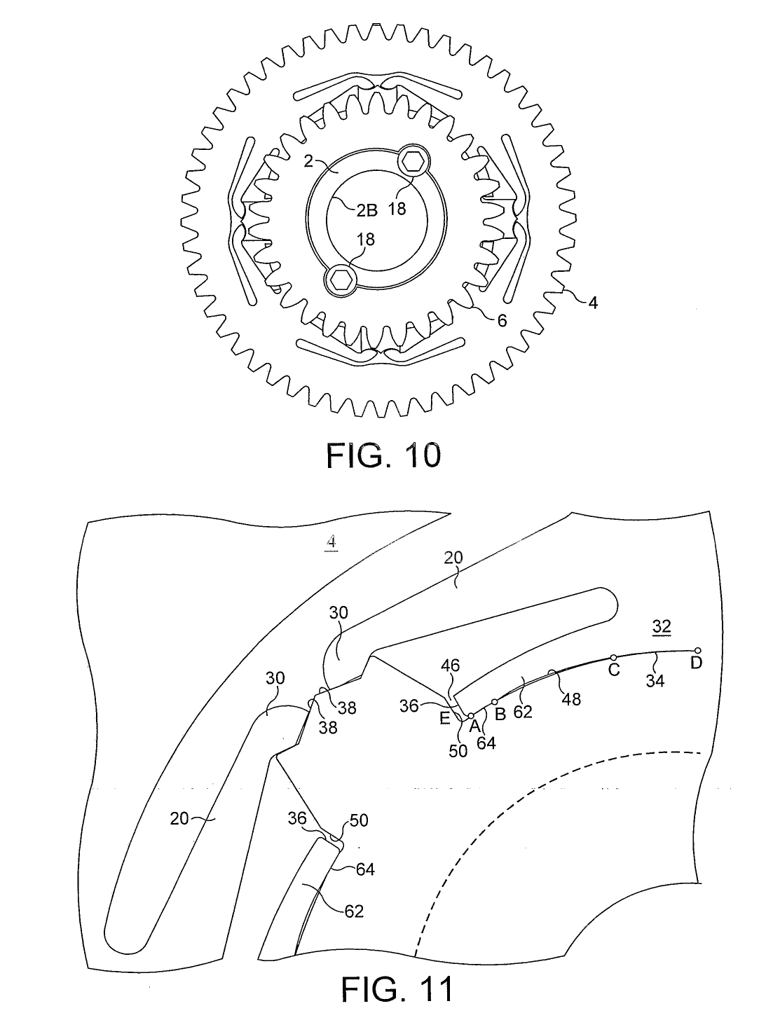

FIG. 10 shows the embodiment of FIG. 8 from the opposite side; and

FIG. 11 is an enlarged view of part of FIG. 7.

FIG. 1 shows a gear unit comprising an inner element 2 in the form of a hub, a toothed outer element 4 and a gear wheel 6. The hub 2 comprises a polygonal portion 8 from which projects a cylindrical portion 10. In the assembled condition, the polygonal portion sits within the outer element 4, and the gear wheel 6 is supported on the cylindrical portion 10. A bore 12 extends through the polygonal portion 8 and forms a part-cylindrical key way 14 in the outer surface of the cylindrical portion 10. There is also a part-cylindrical key way 16 in the inner periphery of the gear wheel 6. In the assembled condition, the key ways 14 and 16 are aligned with each other, and a tapered screw 18 extends through the bore 12 and the aligned key ways 14 and 16 to secure the gear wheel 6 rotationally with respect to the hub 2. The pin 18 has a relatively small taper angle of, for example, 4°-8°. The pin 18 serves as a dowel to prevent relative rotation between the components and to draw the hub 2 firmly into the gear wheel 6.

As shown in FIG. 2, the outer element 4 is formed, at its interior, so as to provide eight fingers 20. The fingers 20 are integral parts of the outer element and extend generally tangentially of the element 4, that is to say they are generally perpendicular to a radial line passing through them. The configuration of the fingers 20 is such that they can each deflect, in the manner of a cantilevered beam, in a direction away from the axis 22 of the outer element 4. The fingers 20 are carried by bodies 24 which extend inwardly from the outer ring 26 of the element 4, on which teeth 28 are provided. The fingers 20 can be regarded as being grouped in pairs, the fingers 20 of each pair projecting towards each other from the respective bodies 24, and terminating in heads 30 (FIG. 3) which lie close to each other.

Each body 24 is provided with an inwardly directed projection 32 which terminates, at its radially innermost extremity, in an arcuate surface 34 centred on the axis 22. The arcuate surfaces 34 terminate at each circumferential end at abutment surfaces 36 which extend radially with respect to the axis 22.

The polygonal portion 8 of the hub 2 is provided, at each of its apices, with a pair of cam surfaces 38 (see FIGS. 3 and 4). As shown in FIG. 4, each cam surface 38 has a concave form comprising flat outer ramp surfaces 40, 42 connected by a smoothly curved transition surface 44. The surfaces 40, 42 are ramped; that is they are inclined radially outwardly in the direction away from the transition surface 44.

Between its apices, the polygonal portion 8 has recesses 46, each of which has a base surface 48 with a shape complementary to that of the contact surface 34 of the respective projection 32. The base surfaces 48 and the contact surfaces 34 are arcuate, centred on the axis 22. They thus provide bearing surfaces at which the outer element 4 can rotate on the hub 2. Each recess 46 also has a pair of side walls 50 which are spaced apart from each other by a distance slightly greater than the distance between the abutment faces 36 of the projections 32.

The outer element 4 is formed so that the fingers 20 must be deflected radially outwardly of their unstressed condition when the polygonal portion 8 of the hub 2 is inserted. Thus, in the configuration shown in FIG. 2, the fingers 20 are pre-stressed. In the “neutral” position of the polygonal portion 8 within the outer element 4, the heads 30 of the fingers assume a minimum energy position in relation to the cam surfaces 38. Thus, as shown in FIG. 4, the contact point 52 is situated at the point along the transition region 44 which is closest to the axis 22, so that the fingers 20 are in their lowest stressed condition.

The hub 2 and the outer element 4 are rotatable relatively to each other to either side of this “neutral” condition about the axis 22. The limits of rotation in each direction are established by contact between one abutment face 36 or the other of each projection 32 against the opposing side wall 50 of the respective recess 46. In the embodiment shown, the maximum relative rotation is 3° to each side of the “neutral” condition. FIG. 3 shows the condition after rotation through 10 in one direction.

Rotation away from the “neutral” condition causes a contact surface 54 of each head 30 to ride over the cam surface 38, so progressively increasing the stress in the finger 20. The configuration of the contact surface 54 and the cam surface 38 is such that the point of contact between the surfaces travels along both the contact surface 54 and the cam surface 38. By way of example, contact points 52A, 52B, 52C and 52D are represented on the contact surface 54, which contact points would engage the cam surface 38 at different degrees of rotation of the hub 2 relative to the outer element 4. An extreme end position is represented in FIG. 4 in dashed outline, in which contact between the contact surface 54 and the cam surface 38 occurs at position 52X.

The profile of the contact surface 54 is such that, at the contact point, the radius of curvature of the contact surface 54 is less than or equal to that of the cam surface 38. Furthermore, the cam surface 38, and particularly the transition surface 44, has a curvature which provides control of the acceleration of the head 30 as the hub 2 rotates from the “neutral” position. This curvature avoids shocks in the operation of the device and provides smooth acceleration of the head 30.

The engagement between the heads 30 and the cam surfaces 38 has two effects. Firstly, a centring effect is achieved tending to return the hub 2 and the outer element 4 to the “neutral” condition. Secondly, the friction between the contact surface 54 and the cam surface 38 creates a damping effect. The cooperation between the fingers 20 and the cam surfaces 38 creates a spring/damper unit having a spring rate determined by the characteristics of the fingers 20 and a damping force determined by the coefficient of friction between the contact surface 54 and the cam surfaces 38, and by the load applied by the fingers 20. By suitable adjustment of these parameters, and particularly the spring rate of the fingers 20, it is possible to de-couple or de-tune vibrations transmitted to the mechanism, so as to prevent, or minimise, the transmission of these vibrations between the hub 2 and the outer element 4.

A bearing surface is achieved by engagement between the projections 32 and the base surfaces 48 of the recesses 46. The damping can be enhanced, as shown in FIG. 5, by means of spring-loaded plungers 56 which can be accommodated within the polygonal portion 8 for engagement with the contact surfaces 34 of the projections 32. As shown in FIG. 5, the plungers 56 are acted upon by resilient cylinders 58 to provide the required spring-loading.

It is also possible to enhance the damping effect by other means, for example by fitting a Belleville spring 60 (FIGS. 5 and 6) to the gear wheel 6 for frictional engagement with the outer element 4.

FIGS. 7 to 9 show a further variation of the device shown in FIGS. 1 to 4. This variant comprises modified bodies 24 and recesses 46.

The recesses 46 as shown in FIG. 7, are circumferentially widened, and the projection 32 is correspondingly circumferentially extended. Thus, the projection 32 has lateral extensions 62 which extend from the projection 32 in the manner of cantilevered beams. As shown in FIG. 9, each extension 62 has a friction surface 64 which engages the base surface 48 of the recess 46. As in the embodiment shown in FIG. 2, the projection 32 has a bearing contact surface 34, extending to both sides of the centreline of the projection 32 to a point C on each side. Between the point C and the point B, representing one edge of the friction surface 64, the extension 62 is spaced from the base surface 48.

The extension 62 is pre-stressed so that it applies a pre-load to the region of the base surface 48 which is engaged by the friction surface 64 between the points A and B. The result of this is that the friction generated between the friction surfaces 64 and the respective base surfaces 48 resists relative rotation between the hub 2 and the outer element 4, so enhancing the damping effect achieved by engagement between the fingers 20 and the cam surfaces 38.

Oil as lubricant is introduced to the inner bearing bore 2B of the hub 2 and is fed by passageways such as radial bores 74 to the cam surfaces 38, the projections 32 and the bearing surfaces 48.

Any suitable means may be provided to retain the outer element 4 on the hub 2. For example, tags 70 (FIG. 7) may extend radially inwardly from the outer element 4 to engage slots 72 in the hub 2 in the regions of the bearing surfaces between the projections 32 and the recesses 46.

An additional enhancement is for the portion of the base surface 48 in the region of contact with the friction surface 64 to be inclined to the circumferential direction. If this is done, relative rotation between the hub 2 and the outer element 4 is accompanied by flexing of the extension 62, thus providing resilient resistance to such rotation, supplementing the effect achieved by the cooperation of the fingers 20 with the cam surfaces 28.

In a specific embodiment in accordance with the invention, effective damping of vibration is achieved by forming the fingers 20 and the extensions 62 so that they have a natural frequency which is higher, by a factor of at least 6 or 7 times, than the frequency of the vibrations to be damped. In a typical form, the natural frequency of the fingers 20 and the extensions 62 is 14 to 25 times higher than the frequency of the vibrations to be damped. By positioning the fingers at a radially outer position with respect to the gear unit, the length of the moment arm at which the frictional damping acts is increased. Although the fingers 20 and the extensions 62 will be subject to centrifugal effects, these are relatively small due to the low mass finger design, even at rotational speeds in excess of 20,000 rpm, and can readily be compensated for by appropriate preloading.

Although the present invention has been described as applied to a double gear assembly, it could be adopted in other components or assemblies. For example, the hub 2 could be mounted or formed on an axle or shaft without a smaller gear such as the gear wheel 6, so that the damping effect would be achieved between the axle or shaft and the outer element 4. Alternatively, the outer element 4 could be replaced by a flywheel or other inertial component which could be suitably weighted to act as a vibration damper. Thus, the present invention could be applied to a crankshaft damper (internal or external with suitable seals), or in any other application where vibration amplitude and dynamic torque reduction or frequency change is required.

1. A rotary device comprising:
an inner element,
an outer element,
a cantilevered resilient finger provided on one of the elements, the finger having a free end,
a cam surface on the other element, the cam surface being frictionally engaged by the free end of the finger thereby to provide resilient resistance to relative rotation of the elements in either direction from a minimum energy position, with damping of rotational oscillations between the elements,
stop means positioned to act between the inner and outer elements to limit their relative rotation.

2. A rotary device as claimed in claim 1, in which the cam surface comprises ramp surfaces which are inclined in opposite directions to each other away from a minimum energy position of the cam surface.

3. A rotary device as claimed in claim 2, in which the ramp surfaces are connected to each other by a transitional surface which includes the minimum energy position.

4. A rotary device as claimed in claim 3, in which the radius of curvature of the transitional surface decreases in the direction away from each ramp surface to the minimum energy position.

5. A rotary device as claimed in claim 3, in which the finger has a contact surface which engages the cam surface, the contact surface having a profile such that the radius of curvature of the contact surface at the point of contact with the cam surface is less than or equal to the radius of curvature of the contacted region of the cam surface in all relative positions of the contact surface on the cam surface.

6. A rotary device as claimed in claim 1, in which the stop means is situated away from the cam surface.

7. A rotary device as claimed in claim 1, in which the stop means limits relative rotation between the elements to an angle of not more than 10°.

8. A rotary device as claimed in claim 7, in which the stop means limits relative rotation between the elements to an angle of not more than 6°.

9. A rotary device as claimed in claim 1, in which the stop means comprises a recess in one of the elements which accommodates a projection extending from the other of the elements.

10. A rotary device as claimed in claim 9, in which the recess is defined by circumferentially spaced walls, the projection having a circumferential extent which is smaller than the spacing between the walls.

11. A rotary device as claimed in claim 9, in which the base of the recess provides rotational support of the outer element on the inner element.

12. A rotary device as claimed in claim 9, in which a resiliently mounted plunger is biased radially into the recess for frictional contact with the projection.

13. A rotary device as claimed in claim 9, in which the projection is provided with at least one extension which frictionally engages the base of the recess under resilient loading.

14. A rotary device as claimed in claim 13, in which extension comprises a pre-stressed resilient arm to provide the resilient loading.

15. A rotary device as claimed in claim 13, in which the projection is provided with two of the said extensions, which extend generally circumferentially to opposite sides of the projection.

16. A rotary device as claimed in claim 1, in which the finger extends generally tangentially with respect to the axis about which rotational oscillations occur.

17. A rotary device as claimed in claim 1, in which the finger is one of a plurality of fingers provided on the respective element.

18. A rotary device as claimed in claim 17, in which the fingers are arranged in pairs, with the fingers of each pair extending towards each other from their connection to the respective element.

19. A rotary device as claimed in claim 1, in which the finger is provided on the outer element, and the surface is provided on the inner element.

20. A rotary device as claimed in claim 19, in which the inner element is of generally polygonal form, the cam surface being provided at an apex of the polygon.

21. A rotary device as claimed in claim 20, in which the inner element is generally square.

22. A rotary device as claimed in claim 20, in which the stop means is disposed at positions between the apices of the inner element.

23. A rotary device as claimed in claim 1, which comprises a gear wheel.

24. (canceled)

25. A rotary device comprising:
an inner element,
an outer element
a cantilevered resilient finger provided on one of the elements, the finger having a free end,
a cam surface on the other element, the cam surface being frictionally engaged by the free end of the finger thereby to provide resilient resistance to relative rotation of the elements in either direction from a minimum energy position, with damping of rotational oscillations between the elements, and
stop means positioned to act between the inner and outer elements to limit their relative rotation, the stop means comprising a first abutment face on the inner element and a second abutment face on the outer element, the first and second abutment faces being spaced apart in the minimum energy position and being in abutment with each other at the limit of relative rotation between the inner and outer elements.
